(19) United States
(12) Patent Application Publication
(10) Pub. No.: US 2011/0292278 A1
(43) Pub. Date: Dec. 1, 2011

(54) ELECTRONIC EQUIPMENT, ACCESSORY AND CAMERA SYSTEM

(75) Inventor: Katsumasa KURIHARA, Saitama-shi (JP)

(73) Assignee: NIKON CORPORATION, TOKYO (JP)

(21) Appl. No.: 13/114,286

(22) Filed: May 24, 2011

(30) Foreign Application Priority Data
May 26, 2010 (JP) P2010-120557
Aug. 27, 2010 (JP) P2010-191056
May 23, 2011 (JP) P2011-115230

(51) Int. Cl. H04N 5/225; G01N 27/416; H02J 7/00

(52) U.S. Cl. 348/372; 320/107; 324/427; 348/E05.024

(57) ABSTRACT

An electronic equipment includes a main body, a mounting portion that is provided in the main body and on which an accessory can be mounted, a battery that is stored in the main body, a battery voltage detection portion that detects an output voltage of the battery, an external power source supply portion which supplies the electric power from the battery to the accessory mounted on the mounting portion, and a control portion which determines the remaining capacity of the battery on the basis of the threshold value to be set based on accessory information on the accessory and a detection result of the battery voltage detection portion.

### BACKGROUND OF THE INVENTION

1. Field of the Invention

Priorities are claimed on Japanese Patent Application Nos. 2010-120557, filed on May 26, 2010; 2010-191056, filed on Aug. 27, 2010; and 2011-115230, filed on May 23, 2011, the contents of which are incorporated herein by reference.

The present invention relates to electronic equipment, an accessory, and a camera system.

2. Description of Related Art

In the related art, as electronic equipment, for example, a power source device is disclosed in JP-A-6-113476. The power source device is constituted of a direct current power source and a power source unit. The power source unit includes a first overcurrent detection circuit, a second overcurrent detection circuit, and a constant voltage control circuit. When an overcurrent is detected in a first overcurrent detection point and a control signal is given from the first overcurrent detection circuit, the constant voltage control circuit limits an output current, and suppresses an instant voltage drop of the output voltage within an operation permissible limit of another electronic circuit package. Furthermore, when an overcurrent is detected in a second overcurrent detection point and the control signal is given from the second overcurrent detection circuit, the constant voltage control circuit shuts off the output current, and does not supply a load side with current.

However, in the power source device of the related art, consideration is made to protect the load from the overcurrent, but consideration is not made to protect the direct current power source from the overcurrent. For that reason, the overcurrent is output over the discharge capability and the direct current power source deteriorates, thus it was difficult to stably and effectively use the direct current power source in the related art.

Furthermore, in the related art, a camera supplies each load with the electric power from a battery provided in a main body. For example, as a typical load, there are an optical system driving portion which drives an optical system in a lens barrel, a charging portion which charges the electric power for causing a light-emitting portion to emit light in a light emission device or the like. When driving such a load, the camera adjusts the electric power consumption of a load (a lens driving mechanism) so as to fall within the range of a defined maximum rated current value, and controls the driving of the load (for example, see JP-A-2001-66489).

According to JP-A-2001-66489, the electric power consumption of the load (the lens driving mechanism) is controlled so as to fall within the range of the defined maximum rated current value from the main body side. The camera can put the electric power consumption of the load within the range of the defined maximum rated current.

In the case of performing such a control, the camera performs the determination of the remaining battery quantity based on a determination threshold value corresponding to the defined maximum rated current.

### SUMMARY OF THE INVENTION

However, when simply performing the determination of the remaining battery quantity based on a determination threshold value corresponding to the defined maximum rated current from the main body side, there is a problem in that a decline in the remaining battery quantity is detected in the state where the remaining battery quantity is left, whereby the battery capacity cannot be effectively used up.

An object of an aspect according to the present invention is to effectively use up the battery capacity.

Electronic equipment in an aspect according to the present invention includes a main body; a mounting portion which is provided in the main body and on which an accessory can be mounted; a battery that is stored in the main body; a battery voltage detection portion that detects an output voltage of the battery; an external power source supply portion which supplies the electric power from the battery to the accessory mounted on the mounting portion; and a control portion which determines a remaining capacity of the battery on the basis of a threshold value to be set based on accessory information regarding the accessory and a detection result of the battery voltage detection portion.

Electronic equipment in as aspect according to the present invention includes a main body; a mounting portion which is provided in the main body and on which an accessory can be mounted; a battery that is stored in the main body; a battery voltage detection portion that detects an output voltage of the battery; an external power source supply portion which supplies the electric power from the battery to the accessory mounted on the mounting portion; and a control portion which controls the accessory based on accessory information regarding the accessory and a detection result of the battery voltage detection portion.

An accessory in an aspect according to the present invention is controlled by the electronic equipment and includes a load portion that is driven by the electric power supplied from the electronic equipment, and a load control portion which notifies the electronic equipment of the electric power consumption information in the load portion.

A camera system in an aspect according to the present invention includes the electronic equipment and/or the accessory.

A camera system in an aspect according to the present invention includes a camera including an attachment and detachment portion where an accessory including a load portion can be attached or detached, a storage portion capable of storing a battery, and a control portion which performs the supply control of the electric power to be output from the battery stored in the storage portion with respect to the accessory mounted on the attachment and detachment portion, and an accessory supplied with electric power from the camera, wherein the accessory includes a load portion that is driven by the electric power supplied from the camera, and a load control portion that notifies the camera of the electric power consumption information in the load portion, the control portion in the camera includes a communication portion which communicates with the accessory and acquires the electric power consumption information in the load portion, and a determination portion that determines a remaining quantity of the battery by comparing a value of a power source voltage, which is output from the battery and is detected, with a predetermined determination threshold value, and the determination portion changes the determination threshold value based on the electric power consumption information acquired by the communication portion.

Furthermore, according to the aspects of the present invention, it is possible to effectively or stably use the battery.

Furthermore, according to the aspects of the present invention, by performing the determination of the remaining battery quantity depending on the electric power consumption of the driven load, there is no need to increase the threshold value which superfluously determines the remaining battery quantity, and the battery capacity can be effectively used up.

### BRIEF DESCRIPTION OF THE DRAWINGS

FIG. 1 is a plan view that shows an exterior of a digital camera according to a first embodiment of the present invention.

FIG. 2A is a block diagram that shows an electrical circuit configuration of the digital camera shown in FIG. 1.

FIG. 2B is a block diagram that shows an inner configuration of an external power source supply portion shown in FIG. 2A.

FIG. 3 is a plan view that shows an electrical circuit configuration of a digital camera according to a second embodiment of the present invention.

FIG. 4 is a block diagram that shows a configuration of an imaging device according to a third embodiment of the present invention.

FIG. 5 is a block diagram that shows the configuration of the imaging device shown in FIG. 4 based on a power supply system.

FIG. 6 is a sequence diagram that shows a sequence of processing in the imaging device shown in FIG. 4.

FIG. 7 is a flow chart that shows a sequence of processing step Sb160 shown in FIG. 6.

### DETAILED DESCRIPTION OF THE INVENTION

### First Embodiment

An aspect for carrying out the present invention when applying electronic equipment according to the present invention to a digital camera will be described.

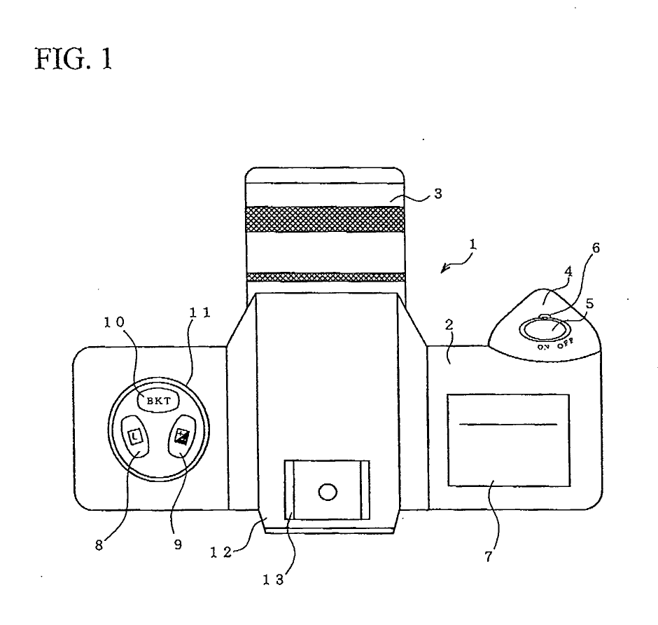

FIG. 1 is a plan view that shows an exterior of a digital camera 1 according to the present embodiment.

The digital camera 1 includes a camera body (main body) 2, and a photographing lens 3 that is provided in the front surface of the camera body 2 in a freely attachable or detachable manner. On the left side of the camera body 2 when viewed from the front, a grip portion 4 is provided which is grasped by a photographer during photographing. On an upper surface of the grip portion 4, a release button 5 and a power source switch 6 are provided as photographing shutter buttons. On an upper surface of the camera body 2 of the front side of the release button 5, a display portion 7 including an LCD (Liquid Crystal Display) is provided. On an upper surface of the camera body 2 of an opposite side of the grip portion 4, a command lock button 8 or an exposure correction button 9 and an auto bracketing button 10 are provided above an operation mode dial 11. On an upper surface of the center of the camera body 2, a penta portion 12 is provided. On an upper surface of the penta portion 12, an accessory shoe (an attachment and detachment portion, a mounting portion) 13 is provided on which an external accessory is mounted.

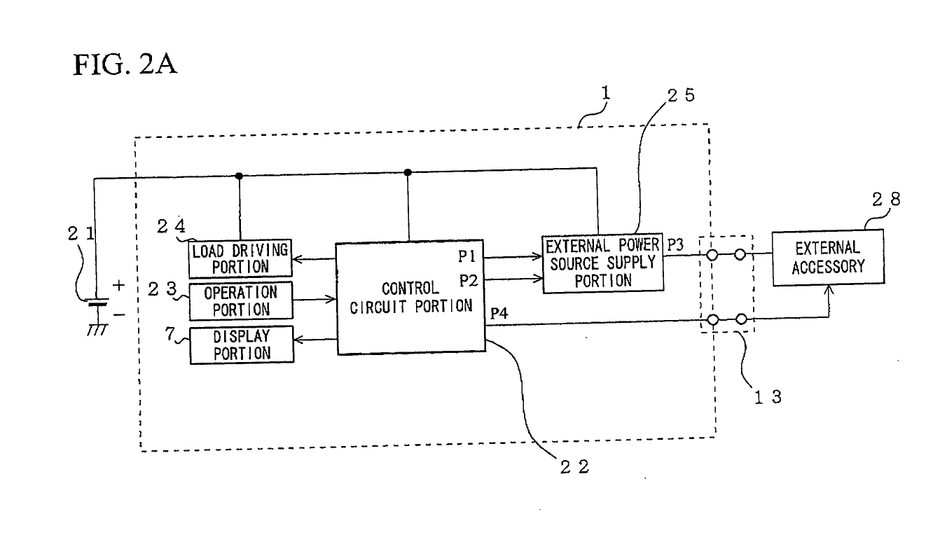

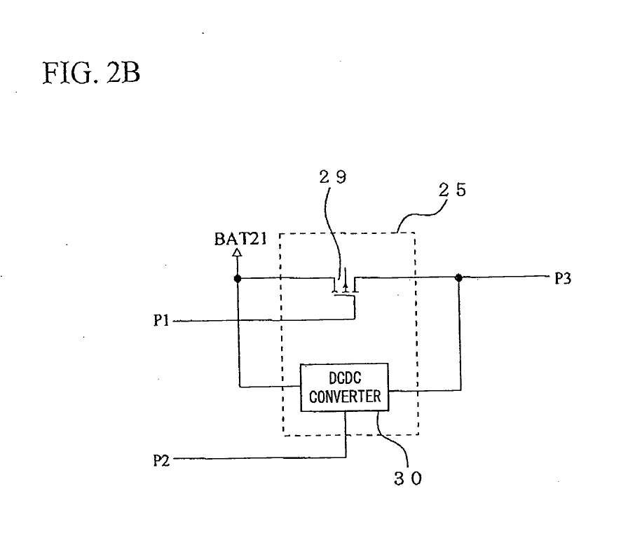

FIG. 2 is a block diagram that shows an electrical circuit configuration of the digital camera 1.

A lithium ion type secondary battery 21 outputs the electric power driving the digital camera 1, and the digital camera 1 is supplied with the electric power from the battery 21 and is operated. A control circuit portion 22, which controls the operation of the digital camera 1, includes a nonvolatile memory formed of an EEPROM (Electrically Erasable Programmable Read Only Memory) or the like and a buffer memory formed of a RAM (Random Access Memory) or the like. The control circuit portion 22 outputs various control signals to each circuit within the digital camera 1 by a CPU (Central Processing Unit), depending on an operation signal to be input from an operation portion 23 using the buffer-memory as an instant memory operation region, according to the control program stored in the nonvolatile memory. The operation portion 23 has a release button 5, a power source switch 6, a command lock button 8, an exposure correction button 9, an auto bracketing button 10, an operation mode dial 11 or the like.

The display portion 7 displays information such as an exposure mode, shutter speed, an aperture value, a focus point, and a remaining capacity of the battery 21, based on the control signal to be output from the control circuit portion 22. The load driving portion 24 drives the load based on the control signal to be output from the control circuit portion 22. The load includes a heavy load which consumes a large amount of electric power upon driving, and a light load which does not consume a large amount of electric power upon driving. The heavy load includes, for example, a lens driving motor which moves the photographing lens 3 in an optical axis direction to control the focus on a subject image to be imaged on an imaging surface of an imaging element, a shutter motor that drives a shutter curtain, an aperture motor that narrows the exposure of the photographing lens 3, a VR (Vibration Reduction) motor that moves an image stabilization lens to perform a shaking correction, or the like.

The external power source supply portion 25 supplies the electric power to be output from the battery 21 from a terminal P3 to an external accessory 28 which is electrically connected to the digital camera 1 via the accessory shoe 13, based on the control signal to be output from terminals P1 and P2 of the control circuit portion 22. The external accessory 28 includes a flash device which illuminates a subject having relatively high electric power consumption, a GPS (Global Positioning System) signal receiver which measures the position of the digital camera 1 having relatively low electric power consumption or the like.

The operation of such an external accessory 28 is controlled based on the control signal to be output from a terminal P4 of the control circuit portion 22. The control circuit portion 22 performs the control of limiting the charge current to a main condenser of the flash device to suppress the electric power consumed by the flash device with respect to the external power source supply portion 25, when the heavy load, for example, the lens driving motor or the like is driven by the load driving portion 24, in the state where the flash device having high electric power consumption (the rated electric power) as the external accessory 28 is connected to the accessory shoe 13. Meanwhile, in the state where the GPS signal receiver having the low electric power consumption (the rated electric power) as the external accessory 28 is connected to the accessory shoe 13, even when the lens driving motor or the like as the heavy load is driven by the load driving portion 24, the constant electric power is supplied by the external power source supply portion 25 without limiting the driving current to the GPS signal receiver. The control circuit portion 22 constitutes an electric power consumption limitation portion which performs the control of limiting the electric power consumed by the electrically connected external accessory 28, depending on the magnitude of the electric power consumption (the rated electric power) of the electrically connected external accessory 28, when the load is driven by the load driving portion 24.

As shown in FIG. 2B, the external power source supply portion 25 includes a FET (Field Effect Transistor) 29, and a DCDC converter 30. When it is detected that the flash device or the like having the high electric power consumption as the external accessory 28 is connected, the control circuit portion 22 outputs the control signal from the terminal P1 to a gate of the FET 29 to turn the FET 29 on, and directly supplies the electric power of the battery 21 from the terminal P3 of the external power source supply portion 25 to the external accessory 28. Meanwhile, when it is detected that the GPS signal receiver or the like of small electric power consumption as the external accessory 28 is connected, the control circuit portion 22 outputs the control signal from the terminal P2 to the DCDC converter 30 to drive the DCDC converter 30, lowers the output voltage of the battery 21 by the DCDC converter 30 to become a fixed constant voltage, and supplies the electric power from the terminal P3 of the external power source supply portion 25 to the external accessory 28. That is, the external power source supply portion 25 supplies the electric power to be output from the battery 21 via the DCDC converter 30 constituting a voltage stabilization circuit to the external accessory 28 or directly supplies the electric power to the external accessory 28 without going via the DCDC converter 30, depending on the magnitude of the electric power consumption of the electrically connected external accessory 28.

The control circuit portion 22 includes a voltage detection portion (a battery voltage detection portion) that detects the output voltage of the battery 21, and a criterion changing portion that detects the type of the external accessory 28 electrically connected to the digital camera 1 and changes a criterion which determines the remaining capacity of the battery 21 depending on the magnitude of the electric power consumption of the detected external accessory 28. In the present embodiment, a value of a discharge termination voltage determining that the remaining capacity of the battery 21 does not exist is used as the criterion. The value of the discharge termination voltage is set to a value which rapidly stops the operation of the digital camera 1 and stably secures the remaining capacity of the battery 21 required for turning the power source of the digital camera 1 off. When the output voltage of the battery 21 reaches the value of the discharge termination voltage, it is considered that the remaining capacity of the battery 21 does not exist.

Furthermore, the control circuit portion 22 constitutes a battery capacity determination portion. The battery capacity determination portion compares the output voltage of the battery 21 detected by the voltage detection portion with the criterion changed by the criterion changing portion, in the present embodiment, the value of the discharge termination voltage changed by the criterion changing portion, and determines the remaining capacity of the battery 21 in the case of using the external accessory 28 of the value of the discharge termination voltage changed by the criterion changing portion. For example, instead of the flash device having the high electric power consumption, when the GPS signal receiver having the low electric power consumption as the external accessory 28 is connected to the digital camera 1, the criterion for determining the remaining capacity of the battery 21 is changed to the value of the discharge termination voltage of the GPS signal receiver lower than that of the flash device by the criterion changing portion, and the value of the changed discharge termination voltage is compared to the value of the output voltage of the battery 21, whereby the remaining value of the battery 21 is determined.

The digital camera 1 includes a fuel gauge function that displays the remaining capacity of the battery 21 determined in the battery capacity determination portion by a numerical value of a percentage. The remaining capacity of the battery 21 determined in the battery capacity determination portion is displayed on the display portion 7 based on the control of the control circuit portion 22. The control circuit portion 22 constitutes the display control portion and displays the remaining capacity of the battery 21 determined by the battery capacity determination portion on the display portion 7. Furthermore, in the present embodiment, the display control portion displays the remaining capacity of the battery 21 determined in the battery capacity determination portion as a percentage, and, for example, when the battery 21 reaches the value of the discharge termination voltage and it is determined that the remaining capacity of the battery 21 does not exist, the display control portion displays 0% on the display portion 7.

According to the digital camera 1 of the present embodiment, depending on the magnitude of the electric power consumption of the external accessory 28 electrically connected to the accessory shoe 13, the criterion for determining the remaining capacity of the battery 21 is changed by the criterion changing portion, the output voltage of the battery 21 detected by the voltage detection portion is compared to the criterion changed by the criterion changing portion, and the remaining capacity of the battery 21 in the case of using the external accessory 28 of the criterion changed by the criterion changing portion is determined by the battery capacity determination portion. For this reason, even in the battery 21 to which the external accessory 28 having the high electric power consumption, for example, the flash device, is connected and at which it is determined that there is no remaining capacity of the battery 21, when the external accessory 28 having the low electric power consumption, for example, the GPS signal receiver, is connected to the battery 21, in some cases, it is decided that the remaining capacity of the battery 21 exists. Thus, it is possible to effectively use up the battery 21 without waste depending on the magnitude of the electric power consumption of the electrically connected external accessory 28.

According to the present embodiment, based on the value of the discharge termination voltage which is changed by the criterion changing portion and at which it is determined that the remaining capacity of the battery 21 does not exist, the remaining capacity of the battery 21 is determined by the battery capacity determination portion, and the determined remaining capacity of the battery 21 is displayed on the display portion 7 as a percentage by the display control portion. For this reason, the remaining capacity of the battery 21 to be displayed depending on the magnitude of the electric power consumption of the electrically connected external accessory 28 is taken as a concrete numerical value.

According to the present embodiment, when the load is driven by the load driving portion 24, the control of limiting the electric power consumed by the external accessory 28 depending on the magnitude of the electric power consumption of the external accessory 28 electrically connected to the accessory shoe 13 is performed by the electric power consumption limitation portion. For this reason, when the load is driven by the load driving portion 24, the possibility that the battery 21 will output the overcurrent over the discharge capacity is eliminated, whereby the degradation of the battery 21 is prevented and the battery 21 can be stably used.

According to the present embodiment, when the magnitude of the electric power consumption of the external accessory 28 electrically connected by the external power source supply portion 25 is small, the electric power to be output from the battery 21 is stably supplied to the external accessory 28 via the DCDC converter 30. Furthermore, when the magnitude of the electric power consumption of the external accessory 28 is large, the electric power is directly supplied to the external accessory 28 without going via the DCDC converter 30. For this reason, it is possible to effectively supply the electric power of the battery 21 to the external accessory 28 depending on the magnitude of the electric power consumption of the electrically connected external accessory 28.

In addition, in the embodiment described above, a configuration was described in which the criterion changing portion changes the value of the discharge termination voltage as the criterion, the battery capacity determination portion determines the remaining capacity of the battery 21 based on the value of the discharge termination voltage changed by the criterion changing portion, and the determined remaining capacity of the battery 21 is displayed on the fuel gauge as a percentage. However, the present invention is not limited thereto. For example, a configuration may be adopted in which the criterion changing portion changes a predetermined threshold value voltage as the criterion, and the battery capacity determination portion compares the output voltage of the battery 21 detected by the voltage detection portion with a predetermined threshold value voltage to determine the remaining capacity of the battery 21. According to the configuration, the output voltage of the battery 21 detected by the voltage detection portion is changed by the criterion changing portion depending on the magnitude of the electric power consumption of the external accessory 28 electrically connected to the accessory shoe 13. For example, the output voltage is compared to two predetermined threshold value voltages, and the remaining capacity of the battery 21 is divided into three stages and is determined by the battery capacity determination portion. For this reason, even in the digital camera 1 that does not have the fuel gauge function of displaying the remaining battery capacity as a percentage, the remaining capacity of the battery 21 is displayed on the display portion 7 by the display control portion, in a stepwise manner, for example, as a battery mark of three stages, depending on the magnitude of the electric power consumption of the electrically connected external accessory 28.

Furthermore, in the embodiment described above, a case was described where the battery 21 is a lithium ion type secondary battery, but the present invention is not limited thereto. For example, the battery 21 may be an alkaline primary battery or the like. When the flash device using such a battery is connected to the accessory shoe 13, the criterion changing portion changes the criterion which is the value of the discharge termination voltage or the predetermined threshold value voltage depending on the type of the electrically connected battery 21.

Furthermore, in the embodiment described above, a case was described where the remaining capacity of the battery 21 is displayed on the display portion 7, but the present invention is not limited thereto. For example, the remaining capacity of the battery 21 may be displayed on a back monitor that is formed of a TFT (Thin Film Transistor) liquid crystal or the like provided on the back surface of the camera body 2. Even in this configuration, the same effect as the above embodiment is exhibited.

Furthermore, in the embodiment described above, a case was described where the external accessory 28 such as the flash device or the GPS signal receiver is connected to the same one accessory shoe 13, and it is selected whether or not the control of limiting the electric power consumption consumed depending on the type of the external accessory 28 connected to the accessory shoe 13 is performed. However, the present invention is not limited thereto. For example, when the flash device is connected to the accessory shoe 13 and the GPS signal receiver is connected to a ten pin connector provided in the side portion of the camera body 2 or the like, whereby, when the external accessories 28 of both of the flash device and the GPS signal receiver are concurrently used, both of the flash device and the GPS signal receiver may be combined with each other, thereby performing the control of limiting the consumed electric power.

Furthermore, in the embodiment described above, a case was described where the limitation of the electric power consumed by the external accessory 28 is performed on the digital camera 1 side, but the present invention is not limited thereto. For example, the control signal may be output from the control circuit portion 22 of the digital camera 1 to the external accessory 28, thereby limiting the electric power consumed by the external accessory 28 on the external accessory 28 side.

Furthermore, in the embodiment described above, the flash device and the GPS signal receiver were described as an example of the external accessory 28, but the present invention is not limited thereto. For example, the external accessory 28 may be an LED (Light-Emitting Diode) illumination device or the like having the high electric power consumption, and the kind of the external accessory 28 is not limited thereto.

### Second Embodiment

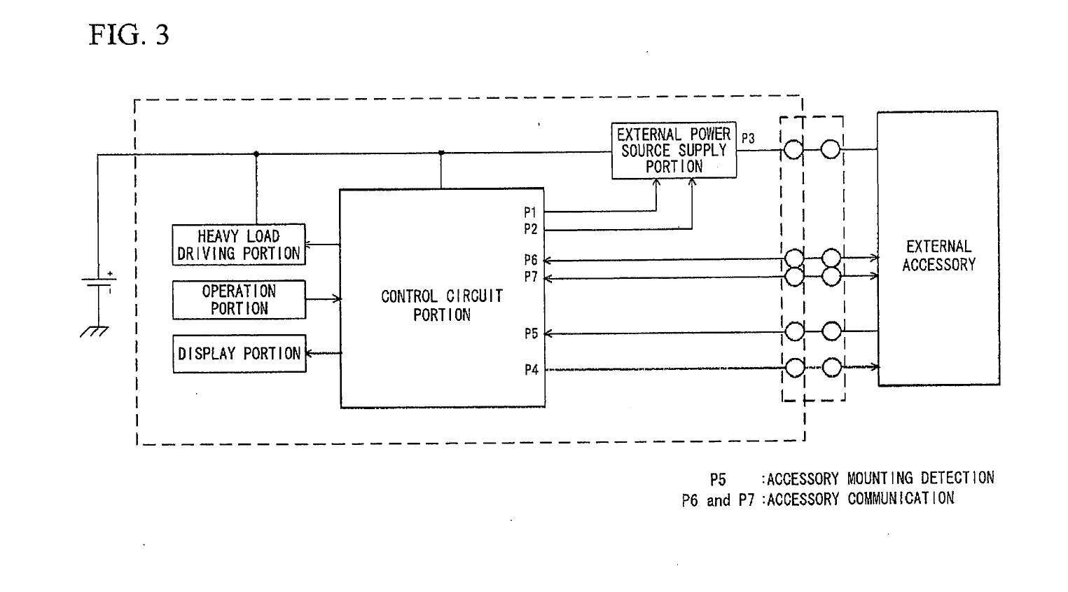

FIG. 3 is a block diagram that shows an electrical circuit configuration of the digital camera 1 in a second embodiment according to the present invention.

In FIG. 3, a control circuit portion 22 is configured so as to further include terminals P5, P6 and P7 that can be electrically connected to the external accessory in addition to the configuration shown in the block diagram of FIG. 2A. In an accessory shoe 131, terminals corresponding to the terminals P5, P6 and P7 are provided. In the accessory shoe 131, a terminal of the main body side and a terminal of the external accessory 28 can be electrically and mechanically connected to each other. In the following description, the descriptions on the components common to the block diagram of FIG. 2A will be suitably omitted.

The digital camera 1 receives a mounting signal from the external accessory 28 via the terminal P5 (a recognition portion) and recognizes the connection with the external accessory 28.

The digital camera 1 communicates with the external accessory 28 via the terminals P6 and P7 (the communication portions). The content of the communication is accessory information including, for example, external accessory load information, an external accessory load information request message, external accessory identification information, an external accessory identification information request message, external accessory state information including the connection state of the external accessory or the like. The accessory information may be memorized in a memory portion (a buffer memory, a nonvolatile memory or the like) depending on the magnitude of the electric power consumption (the rated electric power) of the electrically connected external accessory 28.

In the present embodiment, the external accessory 28 has distinctive external accessory load information (an external accessory load information table). The digital camera 1 transmits the load information request message to the external accessory 28 upon recognizing the connection with the external accessory 28. The external accessory 28 transmits the load information to the digital camera 1 upon receiving the load information request message. The digital camera 1 performs the control of the operation of the external accessory 28, the control of the external power source supply portion 25 and the like as mentioned above based on the received load information.

In addition, the digital camera 1 can temporarily memorize the received load information in the buffer memory and need not read the load information included in the external accessory 28 when performing the control during the temporary memorization, whereby the communication processing of the load information can be omitted.

In the present embodiment, since the external accessory 28 has the distinctive load information, even when a new external accessory is connected to the digital camera 1, the digital camera 1 can perform the control corresponding to the new external accessory.

In addition, if the digital camera 1 can reflect the load information corresponding to the connected external accessory 28 to the control, the maintenance (memory) of the load information or the form of the communication of the load information is not specifically limited.

For example, the digital camera 1 can have a plurality of external accessory load information, and the external accessory 28 can have the distinctive external accessory identification information. The digital camera 1 transmits the external accessory identification information request message to the external accessory 28 upon recognizing the connection with the external accessory 28. The external accessory 28 transmits the external accessory identification information to the digital camera 1 upon receiving the external accessory identification information request message. The digital camera 1 specifies its own external accessory load information corresponding to the received external accessory identification information. The digital camera 1 can perform the control of the operation of the external accessory 28, the control of the external power source supply portion 25 and the like as mentioned above based on the specified external accessory load information.

Furthermore, if the digital camera 1 can reflect the load information corresponding to the connected external accessory 28 to the control, the forms of the correction or the renewal (the recording) of the load information are not specifically limited.

For example, regarding the nonvolatile memory included in the digital camera 1, a terminal for renewing the external accessory load information or the like included in the digital camera 1 may be further provided.

Furthermore, for example, regarding the nonvolatile memory included in the digital camera 1, the external accessory load information included in the digital camera 1 may be corrected or renewed based on the distinctive external accessory load information included in the connected external accessory 28 via the communication portions such as the terminals P6 and P7.

Furthermore, in the embodiment Mentioned above, a configuration was described in which the output voltage of the battery 21 is lowered by the DCDC converter 30, is converted to a fixed constant voltage, and is supplied from the terminal P3 of the external power source supply portion 25 to the external accessory 28, but the present invention is not limited thereto.

For example, if the output voltage of the battery 21 can be lowered and converted to the fixed constant voltage, the DCDC converter 30 may be another variable converter or the like.

Furthermore, in the embodiment mentioned above, the digital camera 1 identifies the external accessory 28 by the communication of the signal via the terminal, but the present invention is not limited thereto.

For example, a distinctive convex portion of the external accessory 28 may be provided on the external accessory 28 side and one or more concave portions fitted into the respective distinctive convex portions of a plurality of external accessories 28 may be provided on the digital camera 1 side, whereby the digital camera 1 may identify the external accessory 28 by using the fitting of the convex portion and the concave portion as a trigger.

Furthermore, for example, dedicated terminals corresponding to the plurality of external accessories 28 respectively may be provided in the digital camera 1 to identify the terminals connected to the external accessories 28, thereby identifying the external accessory 28.

Furthermore, in the embodiment mentioned above, a case was described where the electronic equipment according to the present invention is applied to the digital camera 1, but the present invention is not limited thereto. The present invention may be applied to electronic equipment other than the camera, for example, electronic equipment such as a mobile phone which suitably mounts and uses optional external equipment. Even in a case where the present invention is applied to such electronic equipment, the same effect as the embodiment mentioned above is exhibited.

### Third Embodiment

Next, a third embodiment of the present invention will be described with reference to the drawings.

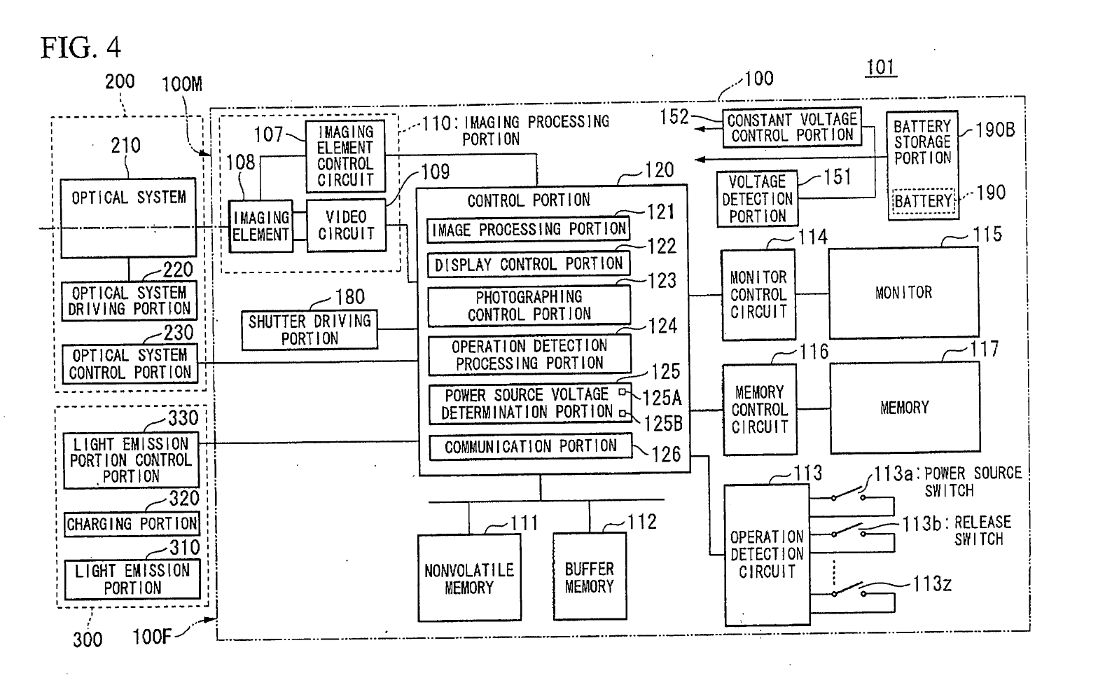

FIG. 4 is a block diagram that shows a configuration of an imaging device (a camera, a digital camera) according to the present embodiment.

An imaging device 101 shown in FIG. 4 includes a camera body (main body) 100, and a lens barrel 200 and a light emission device 300 as accessories mounted on the camera body 100.

In the imaging device 101, the lens barrel 200 includes an optical system 210, an optical system driving portion 220, and an optical system control portion 230.

The optical system 210 in the lens barrel 200 includes an optical element that adjusts the output of light to the imaging element 108, a barrel portion that protects the optical element or the like. For example, the optical system 210 has a function of adjusting the focus, an aperture function of adjusting the quantity of passing light, a zoom function of changing a photographing angle of view, a function of correcting an image vibration due to a hand blurring or the like, and is provided with various sensors that detect the respective states, an encoder or the like. The optical system driving portion 220 drives the optical system 210 by an actuator such as a motor depending on the control signal from the control portion 120, and adjusts the output of light to the imaging element 108. For example, the optical system driving portion 220 performs the focusing control of adjusting the focus of the optical system 210, the exposure control of adjusting the quantity of passing light by the aperture, the zooming control of changing the photographing view of angle, and the sand blurring correction (VR) control of correcting the image vibration due to the hand blurring depending on the control command from the optical system control portion 230. The optical system driving portion 220 drives an auto focus (AF) control motor so as to perform the focusing control of the optical system 210, drives an aperture opening control motor so as to perform the exposure control, drives a power zoom control motor so as to perform zooming control, and drives a (VR) control motor so as to perform the hand blurring correction (VR) control, depending on the respective control commands. Furthermore, the optical system driving portion 220 drives an expansion and contraction control motor that expands or extracts the lens barrel 200 depending on the command from the optical system control portion 230.

The optical system control portion 230 collects the information of various sensors and the encoder provided in the optical system 210 and notifies the control portion 120 of the information. The information notified from the optical system control portion 230 includes lens type information showing the kind of the lens barrel 200, lens focus distance information, an aperture value set by the aperture function, subject focus distance information set by the focus adjustment function, electric power consumption information or the like. The electric power consumption information indicates the electric power consumption consumed in the driving state and is information changed depending on the lens type information or the driving state.

The lens barrel 200 is fixed in the state of being attachable to or detachable from the camera body 100 through the lens mount portion 100M provided in the camera body 100 and is mounted on the camera body 100.

In the imaging device 101, the light emission device 300 includes a light emission portion 310, a charging portion 320, and a light emission portion control portion 330.

The light emission portion 310 irradiates a subject with auxiliary light for securing the illumination necessary for the imaging by the timing depending on the instruction from the camera body 100 side.

The charging portion 320 is supplied with the electric power from the camera body 100 side and charges the electric power required when emitting the light emission portion 310 to an electrostatic capacity included therein.

The light emission portion control portion 330 detects the charging state of the charging portion 320 by various sensors provided in the light emission portion 310, creates the information corresponding to the detected charging amount, and notifies the control portion 120 of the information. The information notified from the light emission portion control portion 330 includes information indicating a charging remaining quantity of the detected charging portion 320, information indicating whether or not the charging portion is in the process of charging, and the like.

Furthermore, the light emission portion control portion 330 controls the charging portion 320 depending on the instruction from the camera body 100, and performs the charging in the charging portion 320. Moreover, the light emission portion control portion 330 performs the control of causing the light emission portion 310 to emit light using the charged electric power.

In addition, although it is described that the light emission device 300 in the present embodiment is connected to the camera body 100, the light emission device 300 may be provided in the camera body 100 without being limited to another form.

The light emission device 300 is mounted on the camera body 100 via a light emission device mount portion (a flash shoe) 100F provided in a cover portion with a pentagon prism or the like stored therein in the state of being attachable to or detachable from the camera body 100.

In the imaging device 101, the camera body 100 includes an imaging processing portion 110, a nonvolatile memory 111, a buffer memory 112, an operation detection circuit 113, a monitor control circuit 114, a monitor 115, a memory control circuit 116, a memory 117, a control portion 120, a voltage detection portion (a battery voltage detection portion) 151, a constant voltage control portion 152, and a shutter driving portion 180. Furthermore, in the camera body 100, a battery storage portion 190B is provided in which a battery 190 for supplying the electric power driving the imaging device 101 is stored.

The imaging processing portion 110 in the camera body 100 includes an imaging element control circuit 107, an imaging element 108 and a video circuit 109. The imaging element 108 is a light reception element such as a CCD (Charged Coupled Device) or CMOS (Complementary Metal Oxide Semiconductor) sensor, and converts the image, which is output from the optical system 210 and is imaged, into an electrical signal to output an analog image signal.

The video circuit 109 and the imaging element control circuit 107 are connected to the imaging element 108. The video circuit 109 amplifies the image signal output by the imaging element 108, and converts the image signal to a digital signal. The imaging element control circuit 107 drives the imaging element 108, thereby controlling the operation such as the conversion of the image imaged by the imaging element 108 to the image signal or the output of the converted image signal.

In the nonvolatile memory 111, a program for operating the control portion 120, or the imaged and created image data, information indicating the device state, information indicating the electric power consumption of the load, information such as various settings input from a user or an imaging condition is memorized.

Furthermore, the information indicating the device state includes voltage information of the battery 190 stored in the battery storage portion 190B of the camera body 100, information indicating the control state of various actuators of the lens barrel 200 or the like.

Furthermore, information indicating the electric power consumption of the load includes the electric power consumptions of each actuator provided in the lens barrel 200, the electric power consumption of the charging portion 320 provided in the light emission device 300 or the like.

The buffer memory 112 is a memory region of temporary information to be used in the control processing of the control portion 120, and, for example, the image signal to be output from the imaging element 108, the image data created depending on the image signal or the like is temporarily memorized by the control portion 120.

The operation detection circuit 113 detects the operation of a user input to the input portion, and inputs the detected operation information to the control portion 120 as the control signal. The input portion includes, for example, a power source switch 113a, release switches 113b, . . . , 113z, and the like.

The monitor control circuit 114 performs the display control such as turning on and off light or a brightness adjustment, or the processing of displaying the image data to be output from the control portion 120 on the monitor 115.

The monitor 115 displays the image data and is constituted by, for example, a liquid crystal display (LCD: Liquid Crystal Display).

The memory control circuit 116 performs the processing of controlling the input and output of information of the control portion 120 and the memory 117, thereby, for example, memorizing information such as the image data created by the control portion 120 in the memory 117, the processing of reading information such as the image data memorized in the memory 117 and outputting the information to the control portion 120, and the like. The memory 117 is, for example, a memory medium such as a memory card capable of being plugged into or unplugged from the camera body 100, and the image data or the like created by the control portion 120 is memorized therein.

The voltage detection portion 151 detects the power source voltage to be output from the battery 190, that is, the input voltage of the constant voltage control portion 152 by the timing according to the instruction from the control portion 120. The voltage detection portion 151 supplies the detected power source voltage to the control portion 120.

The constant voltage control, portion 152 converts the electric power to be supplied from the battery 190 stored in the battery storage portion 190B, and performs the constant voltage control of stabilizing the voltage to be output of the power source. The constant voltage control portion 152 stabilizes the output voltage and supplies the same to the control portion 120 in the camera body 100 and the control portion (for example, the optical system control portion 230 of the lens barrel 200) of the accessory as the power source.

The shutter driving portion 180 drives the shutter that shields the light reception surface of the imaging element 108; and controls the opening and closing of the shutter. Since the shutter driving portion 180 has the higher electric power consumption under driving than the loads of the battery 190 in the camera body 100, the shutter driving portion 180 is classified as a heavy load.

In addition, there is a power source system where the electric power is directly supplied from the battery 190 without being stabilized and being controlled by the constant voltage control portion 152. Hereinafter, a power source system in the imaging device will be described.

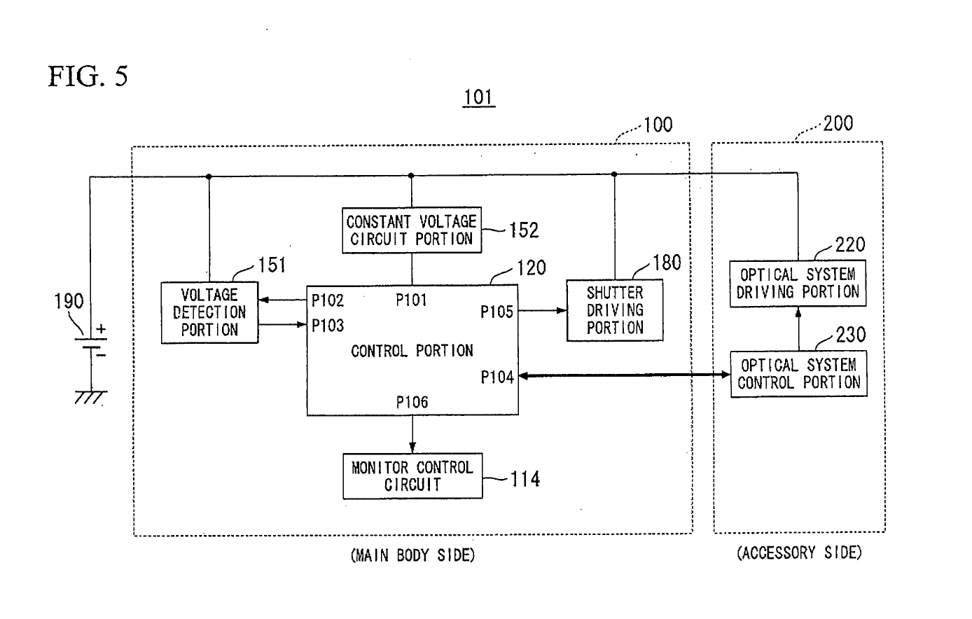

FIG. 5 is a block diagram that centrally shows the power source system in regard to the configuration of the imaging device. The same configuration as that of FIG. 4 will be denoted by the same reference numerals.

In the block diagram shown in FIG. 5, a lens barrel 200 is shown as an example of an accessory.

In FIG. 5, the constant voltage control portion 152 is connected to the control portion 120 via a terminal P101, the voltage detection portion 151 is connected to the control portion 120 via the terminal P102 and the terminal P103, the optical system control portion 230 is connected to the control portion 120 via the terminal P104, the shutter driving portion 180 is connected to the control portion 120 via the terminal P105, and the monitor, control circuit 114 is connected to the control portion 120 via the terminal P106.

The battery 190 stored in the battery storage portion 190B supplies the electric power driving the imaging device 101. The constant voltage control portion 152, the shutter driving portion 180, and the optical system driving portion 220 of the lens barrel 200 are connected to the battery 190, and the electric power from the battery 190 is supplied to each functional portion as the power source.

In order to heighten the conversion efficiency, the electric power from the battery 190 is directly supplied to the shutter driving portion 180 (the heavy load) in the camera body 100 or the optical system driving portion 220 of the lens barrel 200 to be connected to the camera body 100. The power source voltage to be output from the battery 190 is changed by the charging state of the battery 190, the electric power supply state to the load, the environmental temperature or the like.

For that reason, the voltage is supplied to each functional portion, in which the power source voltage to be supplied needs to be stabilized, in each functional portion in the camera body 100 via the constant voltage control portion 152 so as to enter a certain predetermined power source voltage fluctuation width. The constant voltage control portion 152 avoids the influence of the power source voltage fluctuation due to a factor such as a load fluctuation by providing the stabilized voltage as a power source of each functional portion within the camera body 100. In order for an output voltage of the constant voltage control portion 152 to be stabilized, it is required that a range of an input voltage thereof be within a predetermined range.

Returning to FIG. 4, the control portion 120 will be described.

The control portion 120 is formed of a CPU (Central Processing Unit) or the like that controls the operations of each portion of the camera body 100 based on the program stored in the nonvolatile memory 111. For example, the control portion 120 performs the putting of the power source to the camera body 100, the driving control of the optical system 210 via the optical system driving portion 220, the driving control of the imaging element 108 via the imaging element control circuit 107, the display control of the monitor 115 via the monitor control circuit 114, and the control of the photographing processing of a subject detected by the imaging element 108 depending on the operation information from a user to be input to the operation detection circuit 113.

The control portion 120 includes an image processing portion 121, a display control portion 122, a photographing control portion 123, an operation detection processing portion 124, a power source voltage determination portion 125, and a communication portion 126.

The image processing portion 121 in the control portion 120 performs the image processing of reading the image signal, which is output to the video circuit 109 caught in the imaging region of the imaging element 108, and of creating the image data based on the read image signal. The image processing portion 121 memorizes the image data created by the image processing in the buffer memory 112. The display control portion 122 reads the image data, which is created by the image processing portion 121 and is memorized in the buffer memory 122, for each certain time interval, displays the read image data on the monitor 115 in real time, and records the image data on the memory 117 as a moving picture. Furthermore, the display control portion 122 displays the charging remaining quantity of the battery depending on the determination result of the power source voltage determination portion 125 on the monitor 115.

The photographing control portion 123 outputs the necessary control signal to each portion depending on the input of the control signal such as the photographing processing start command or the photographing processing finish command based on the operation input of a user from the operation detection circuit 113. The photographing control portion 123 drives the optical system 210 when the photographing processing start command is input, and performs the imaging processing of creating the image data. The photographing control portion 123 performs the control such as the focusing, the exposure control, the zooming, and the hand blurring correction (VR) control of the optical system 210 via the optical system control portion 230 depending on the photographing condition that is input from a user in advance.

Furthermore, the photographing control portion 123 drives the shutter driving portion 180 upon performing the photographing, controls the opening and closing of the shutter, and irradiates the light reception surface of the imaging element 108 with light from the lens barrel 200 for a predetermined time length depending on the quantity of light.

In addition, the photographing control portion 123 controls the light emission device 300 and causes the light emission portion 310 to emit light synchronously with the imaging timing, as necessary.

In addition, the operation detection processing portion 124 determines the operation information of a user detected by the operation detection circuit 113, records the determined information on the memory 117, and outputs the control commands of the required various processing. For example, in the auto focus (AF) processing, when the AF operation is detected by the operation detection circuit 113, an AF control motor, which controls the AF control of the optical system driving portion 220 in the lens barrel 200, is driven, to adjust the optical system 210, thereby performing the AF control.

The power source voltage to be output from the battery 190 is detected by the voltage detection portion 151 and the detected power source voltage is compared to the determination threshold value, whereby the power source voltage determination portion 125 determines the remaining quantity in the battery 190.

The power source voltage determination portion 125 has determination portions 125A and 125B that determine the power source voltage detected by the voltage detection portion 151. The respective determination portions change the determining method of the detected power source voltage depending on the type or state of the optical system driving portion 220 (the load portion).

The determination portion 125A (a first determination portion) determines in which range, among the ranges divided by the determination threshold value, a value of an average power source voltage of the values of the power source voltage repeatedly detected by the voltage detection portion 151 is included.

Furthermore, the determination portion 125B (a second determination portion) respectively determines in which range, among the ranges divided by the determination threshold value, values of the power source voltage repeatedly detected by the voltage detection portion 151 are included. Furthermore, the power source voltage determination portion 125 determines in which range, among the ranges divided by the determination threshold value, the value of the power source voltage is included based on the number of determination results showing the same determination result, by the determination result through the determination portion 125B.

When a main load is in the lens barrel 200, the power source voltage determination portion 125 can select the determination portion depending on the driving electric energy amount driving the optical system driving portion 220 (the driving portion), the type of operating actuator, and the operation situation. The power source voltage determination portion 125 may select any one of the determination portions 125A and 125B depending on whether or not the periods of driving the optical system driving portion 220 (the driving portion) overlap. For example, the power source voltage determination portion 125 selects the determination portion 125A when the periods of driving the optical system driving portion 220 (the driving portion) overlap, and selects the determination portion 125B when the driving periods do not overlap but the optical system driving portion 220 is exclusively driven.

Otherwise, when the main load is in the light emission device 300 (FIG. 4), the power source voltage determination portion 125 changes the determination portion that determines the detected power source voltage, depending on the kind or state of the charging portion 320 (the load) in the light emission device 300. For example, when driving the charging portion 320 (the driving portion) in the light emission device 300, such as immediately after causing the light emission portion 310 to emit light, in a case where there is a large disc urge amount from the electrostatic capacity included in the charging portion 320 and it is determined that a large amount of charging is necessary from the charging situation, the power source voltage determination portion 125 can rapidly recover the charging state by performing the charging according to a limit value of the charging capability range. In this case, by selecting the determination portion 125A and causing the same to perform the determination, even in the voltage range in which the voltage change rate is increased, it is possible to derive the result depending on an actual charging amount. In addition, the calculation processing by the determination portion 125A is known as a movement average calculation processing.

Meanwhile, when the charging amount is recovered or when the discharge amount is slightly added and in the charging state, by selecting the determination portion 125B and causing the same to perform the determination and intermittently switching over the timing of the charging and the discharging, even in a case where the detection voltage fluctuates synchronously with the charging timing, it is possible to derive a stable result without frequent fluctuation in the determination result.

Furthermore, the power source voltage determination portion 125 changes the determination threshold value depending on the electric power consumption amount of the load portion (for example, the optical system driving portion 220). The power source voltage determination portion 125 acquires the kind or state of the load portion (for example, the optical system driving portion 220) as the electric power consumption information. The electric power consumption information is information depending on the consumption electric energy amount of the load portion (the optical system driving portion 220), and the power source voltage determination portion 125 acquires the electric power consumption information from the load control portion (for example, the optical system control portion 230) in advance, and changes the determination threshold value based on the acquired electric power consumption information.

For example, the communication portion 126 is connected to the load control portions provided in each load (the accessory) in a communicable state. The communication portion 126 delivers the control command driving the load portion to the load control portion by communicating with the load control portion of the accessory. Furthermore, the communication portion 126 acquires the electric power consumption information in the load portion by communicating with the load control portion of the accessory.

### <Sequence of Determination Processing>

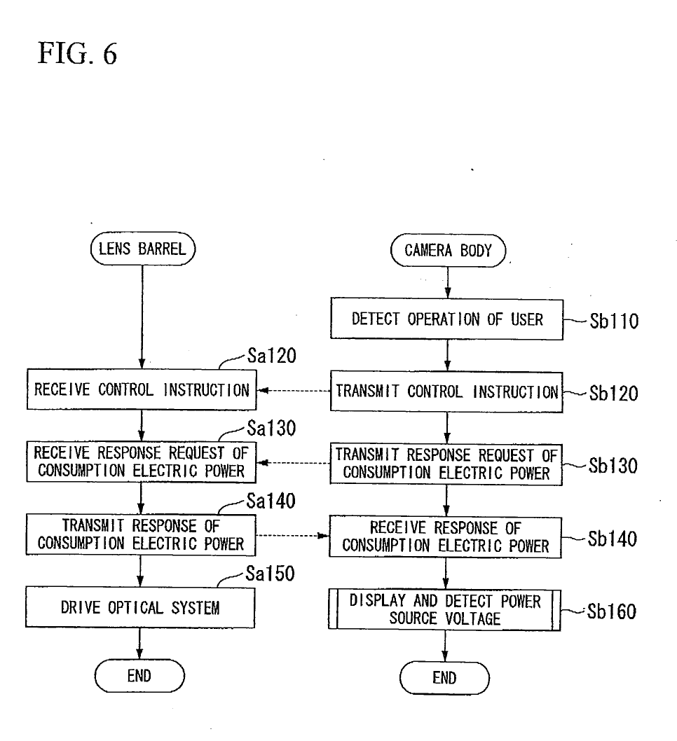

FIG. 6 is a sequence diagram that shows the sequence of the processing in the imaging device.

In FIG. 6, the communication processing between the control portion 120 of the camera body 100 and the optical system control portion 230 of the lens barrel 200 and the processing to be performed in each portion are shown in combination with each other.

Firstly, the control portion 120 of the camera body 100 detects a user's operation by the operation detection processing portion 124. (step Sb110). The control portion 120 transmits the control command for driving the optical system 210 to the optical system control portion 230 of the lens barrel 200 by a message format depending on the detected operation of a user. The message corresponding to the control command is transmitted to the optical system control portion 230 of the lens barrel 200 by the communication portion 126 (step Sb120).

The optical system control portion 230 of the lens barrel 200 receives the message corresponding to the control command from the communication portion 126 (step Sa120).

The control portion 120 of the camera body 100 transmits the request of the electric power consumption information required when driving the optical system 210 according to the control command to the optical system control portion 230 of the lens barrel 200 by the message format (step Sb130).

In addition, the processing of the step Sb120 and the step Sb130 may be transmitted while being included in the same message.

The optical system control portion 230 of the lens barrel 200 receives the message corresponding to the control command for driving the optical system 210 from the control portion 120 of the camera body 100 in step Sb120, and then receives the message corresponding to the request of the electric power consumption information indicating the electric power consumption required when driving the optical system 210 according to the control command (step Sa130).

The optical system control portion 230 of the lens barrel 200 transmits the request of the electric power consumption information required when driving the optical system 210 to the control portion 120 of the camera body 100 by the message format, depending on the request based on those messages (step Sa140).

Furthermore, the optical system control portion 230 of the lens barrel 200 starts the driving of the optical system 210 depending on the received control command, and continues the driving until the necessary processing is finished (step Sa150).

Furthermore, the control portion 120 of the camera body 100 receives the message corresponding to the request of the electric power consumption information required when driving the optical system 210 from the optical system control portion 230 of the lens barrel 200 by the communication portion 126 (step Sb140).

The power source voltage determination portion 125 of the control portion 120 determines the power supply voltage output by the battery 190 depending on the acquired electric power consumption information. The power source voltage determination portion 125 determines the power source voltage output by the battery 190 by the determination portion selected according to the electric power consumption information acquired by the step Sb140, and displays the charging remaining quantity of the battery 190 on the monitor 115 by the monitor control circuit 114 (step Sb160).

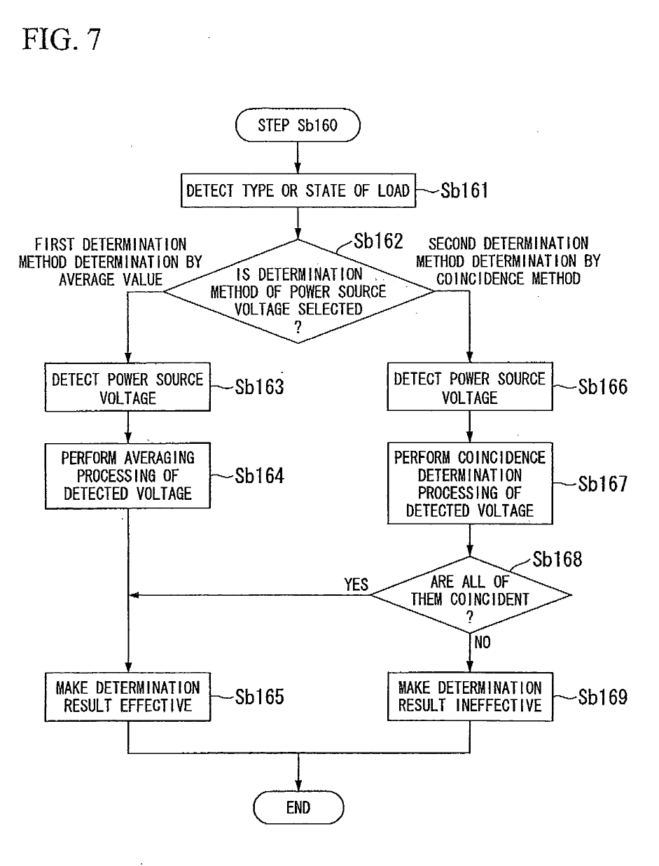

Next, the processing of the step Sb160 mentioned above will be described with reference to FIG. 7.

FIG. 7 is a flow chart that shows the sequence of the processing in the step Sb160.

The processing shown in FIG. 7 is repeatedly performed depending on the timing counted by a clock portion (not shown) provided in the control portion 120.

The power source voltage determination portion 125 detects the type or state of the load acquired as the electric power consumption information in the step Sb140 (FIG. 6) (step Sb161).

The power source voltage determination portion 125 determines whether or not the load is a heavy load by the electric power consumption information, thereby selecting the determination portion that performs the determination of the power source voltage (step Sb162). That is, the determination portion of the power source voltage is selected based on the type and state of the load acquired as the electric power consumption information. By means of the selection, any one processing is performed, that is, when the determination portion 125A is selected, the processing from the step Sb163 by the determination portion 125A is performed, or when the determination portion 125B is selected, the processing from the step Sbl 66 by the determination portion 125B is performed.

When the load is determined as the heavy load by means of the result of determination in the step Sb162 (step Sb162: a first determination method), “Determination by the average value” is performed by the determination portion 125A by the sequence as below.

The voltage detection portion 151 detects the power source voltage, and memorizes the value of the detected power source voltage in the buffer memory 112 (step Sb163).

The power source voltage determination portion 125 performs an averaging processing of averaging the value of the repeatedly detected power source voltage memorized in the buffer memory 112 and the value of the power source voltage detected in the step Sb163 to calculate the average power source voltage.

The power source voltage determination portion 125 determines in which range, among the ranges divided by the determination threshold value, the value of the calculated average power source voltage is included, and sets the value as the determination value of the present power source voltage (step Sb164).

The power source voltage determination portion 125 determines that the determination result considered as the determination value of the present power supply voltage is an efficient determination. The display control portion 123 displays the charging remaining quantity of the battery 190 on the monitor 115 by the monitor control circuit 114 according to the determination result (step Sb165).

Furthermore, when it is determined that the load is not the heavy load by the determination result in the step Sb162 (step Sb162: a second determination method), “Determination by coincidence method” is performed by the determination portion 125B according to the sequence as below.

The voltage detection portion 151 detects the power supply voltage and memorizes the value of the power source voltage detected by in the buffer memory 112 (step Sb166).

The power source voltage determination portion 125 determines in which range, among the ranges divided by the determination threshold value, the value of the repeatedly detected power source voltage memorized in the buffer memory 112 and the value of the power supply voltage detected in the step Sb163 are included (step Sb167).

The power source voltage determination portion 125 determines the value of the power source voltage based on the value of the determination result in which the results determining the values of each power source voltage in each determination indicate the same determination results.

For example, it is determined whether or not the respective determination results are coincident to each other. That is, it is determined whether or not all the determination results are determined to be within the range of the same power source voltage (step Sb168).

In the case that, as a result of the determination in the step Sb168, all the determination results are within the range of the same power source voltage (step Sb168: Yes), the process progresses to the processing of the step Sb165 which sets the determination result as an efficient determination result.

In the case that, as a result of the determination in the step Sb168, it is determined that some determination results are within the range of another power source voltage (step Sb168: No), the determination result is set to an ineffective determination result (step Sb169).

In the imaging device 101, by performing the determination depending on the magnitude of the electric power consumption of the load, even in the state where the heavy load having the high electric power consumption is driven, the remaining battery quantity can be accurately determined. By the driving of the heavy load having the high electric power consumption, the power source voltage to be output by the battery 190 fluctuates.

In the imaging device 101, the determination of the remaining battery quantity is performed depending on the electric power consumption of the driven load and the electric power consumption of the load is controlled to drive and control the load so that the electric power consumption of the load enters the range of the supply capability of the electric power to be supplied from the battery, whereby the battery capacity can be effectively used up.

In addition, the present invention is not limited to the various embodiments, but can be changed within the scope of not departing from the gist of the present invention. The power source voltage determination in the camera body and the imaging device of the present invention is merely an embodiment, and the number and the period of the quantity of information in the averaging processing can be suitably set to predetermined values in advance.

In the embodiment mentioned above, in the imaging device 101 and the camera body 100, (1) an attachment and detachment portion (a mounting portion, a lens mount portion 100M, and a light emission device mount portion (a flash shoe) 100F) capable of attaching and detaching accessories (the lens barrel 200 and the light emission device 300) including the load portion; a battery storage portion 190B capable of storing the battery 190; and a control portion 120, which performs the supply and the control of the electric power to be output from the battery 190 stored in the battery storage portion 190B with respect to the accessories mounted on the attachment and detachment portion, are included. The control portion 120 includes the communication portion 126 which communicates with the accessories and acquires the electric power consumption information in the load portion, and the power source voltage determination portion 125 which determines the remaining quantity of the battery 190 by comparing the value of the power source voltage with a predetermined determination threshold value by the detection of the power source voltage to be output from the battery 190. The power source voltage determination portion 125 changes the determination threshold value based on the electric power consumption information acquired from the communication portion 126.

By including such a configuration, the imaging device 101 (the camera body 100) can obtain the electric power information required for driving the member from the accessory side upon driving the member of the accessory side in each time (whenever the camera body 100 requires the operation to the accessory). Furthermore, since the obtained information can be correctly determined, it is possible to reflect the information to the battery check based on the determination result.

(2) Furthermore, the power source voltage determination portion 125 acquires the electric power consumption information in the load portion from the load portion in advance, and changes the determination threshold value based on the acquired electric power consumption information.

(3) Furthermore, the power source voltage determination portion 125 acquires the type or state of the load portion as the electric power consumption information, and changes the determination method of the detected power source voltage depending on the type or state of the load portion.

In this manner, by setting the information already used in another processing to the determination condition, the necessary information can be defined without defining new information, which can simplify the processing.

(4) Furthermore, the power source voltage determination portion 125 includes the first determination portion which determines in which range, among the ranges divided by the determination threshold value, the value of the average power source voltage averaging the power source voltages repeatedly detected by the voltage detection portion 151 is included; and the second determination portion which determines in which range, among the ranges divided by the determination threshold value, the values of the power source voltages repeatedly detected by the voltage detection portion 151 are included, respectively, and which determines in which range, among the ranges divided by the determination threshold value, the value of the power source voltage is included based on the number of the determination results showing the same determination result.

In this manner, since it is possible to perform the determination processing suitable for the fluctuation tendency of the power source voltage by applying another calculation processing method, it is possible to select the determination method that can reduce the influence due to the fluctuation in the power source voltage.

(5) Furthermore, the load portion has any one of the optical system driving portion 220 that drives the included optical system 210 or the charging portion 320 that charges the electric power causing the included light emission portion 310 to emit light.

(6) Furthermore, the optical system driving portion 220 includes a plurality of driving portions in which the respective driving periods are independently controlled, and the power source voltage determination portion 125 selects any one of the first determination portion and the second determination portion depending on whether or not the periods driving the driving portions overlap. By adopting such a method, it is possible to avoid the influence of the battery 190 due to a decline in power source voltage in the state of driving the optical system 210.

(7) Furthermore, in the power source voltage determination portion 125, the charging control portion 330 selects any one of the first determination portion and the second determination portion depending on the charging state of the charging portion 320. By adopting such a method, it is possible to avoid the influence of the battery 190 due to a decline in power source voltage in the state of charging the condenser.

(8) Furthermore, the accessories (the lens barrel 200 and the light emission device 300) include the load portion that is driven by the electric power supplied from the camera, and the load control portion that notifies the camera of the electric power consumption information in the load portion.

(9) Furthermore, in the accessories, the determination threshold value, which determines the remaining quantity of the battery supplying the electric power, is changed based on the notified consumption electric energy amount information.

By including such a configuration, the imaging device 101 can effectively use up the battery capacity by performing the determination of the remaining battery quantity depending on the electric power consumption of the driven load without the need to superfluously increase the threshold value determining the remaining battery quantity.

In addition, the load is able to be driven by the necessary electric power consumption, whereby the load is not limited to the setting value that is superfluously limited by the camera body 100 side. Thus, the load can be driven so that the electric power consumption is not superfluously limited, whereby the responsibility is not limited like the previous driving method. Particularly, even in a case where the remaining battery quantity declines and approaches the limit value, the responsibility of the load in the lens barrel 200 is secured, and it is possible to instantly supplement the subject.

Furthermore, the imaging device 101 is able to adjust the electric power consumption of the load to drive and control the load such that the electric power consumption of the load enters the range of the supply capability of the electric power to be supplied from the battery. As a result, since the suitable remaining battery quantity can be determined, the imaging device 101 can effectively use up the battery capacity by adjusting the electric power consumption of the load to drive and control the load such that the electric power consumption of the load enters the range of the supply capability of the electric power to be supplied from the battery.

In an embodiment, the electronic equipment includes an external power source supply portion that supplies electrically connected external equipment with the electric power to be output from the battery; a voltage detection portion that detects the output voltage of the battery; a criterion changing portion that changes the criterion for determining the remaining quantity of the battery depending on the magnitude of the electric power consumption of the electrically connected external equipment; a battery capacity determination portion that compares the output voltage of the battery detected by the voltage detection portion with the criterion changed by the criterion changing portion and determines the remaining capacity of the battery in the case of using the external equipment of the criterion changed by the criterion changing portion; and a display control portion that displays the remaining capacity of the battery determined by the battery capacity determination portion.

In the embodiment mentioned above, the criterion changing portion changes the predetermined threshold value voltage as the criterion, and the battery capacity determination portion can compare the output voltage of the battery detected by the voltage detection portion with a predetermined threshold value voltage to determine the remaining quantity of the battery.

In the embodiment mentioned above, the criterion changing portion changes the value of the discharge termination voltage determining that the remaining capacity of the battery does not exist as the criterion, the battery capacity determination portion determines the remaining capacity of the battery based on the value of the discharge termination voltage changed by the criterion changing portion, and the display control portion can display the remaining capacity of the battery determined in the battery capacity determination portion as a percentage.

In the embodiment mentioned above, the electronic equipment can include a load driving portion that drives the load by the electric power to be output from the battery; an external power source supply portion that supplies the electrically connected external equipment with the electric power to be output from the battery; and an electric power consumption limitation portion that performs the control of limiting the electric power consumed by the electrically connected external equipment depending on the magnitude of the electric power consumption of the electrically connected external equipment when the load is driven by the load driving portion.

In the embodiment mentioned above, the external power source supply portion can supply the electric power to be output from the battery to the external equipment via the voltage stabilization circuit or can directly supply the electric power to the external equipment without going via the voltage stabilization circuit, depending on the magnitude of the electric power consumption of the electrically connected external equipment.

In an embodiment, the camera includes an attachment and detachment portion where the accessory including the load portion can be attached or detached, a storage portion capable of storing the battery, and a control portion which performs the supply control of the electric power to be output from the battery stored in the storage portion with respect to the accessory mounted on the attachment and detachment portion, wherein the control portion includes a communication portion which communicates with the accessory and acquires the electric power consumption information in the load portion, and a determination portion that determines the remaining quantity of the battery by comparing the value of the power source voltage, which is output from the battery and is detected, with a predetermined determination threshold value, and the determination portion changes the determination threshold value based on the electric power consumption information acquired by the communication portion.

In the embodiment mentioned above, the determination portion can acquire the electric power consumption information from the load portion in advance and can change the determination threshold value based on the acquired electric power consumption information.

In the embodiment mentioned above, the determination portion can acquire the kind or state of the load portion as the electric power consumption information and can change the determination portion of the detected power source voltage depending on the kind or state of the load portion.

In the embodiment mentioned above, the determination portion can include the first determination portion determining in which range, among the ranges divided by the determination threshold value, the value of the average power source voltage averaging the repeatedly detected power source voltages is included; and the second determination portion which determines in which range, among the ranges divided by the determination threshold value, the values of the repeatedly detected power source voltages are included, and which determines in which range, among the ranges divided by the determination threshold value, the value of the power source voltage is included based on the number of the determination results showing the same determination result.

In the embodiment mentioned above, the load portion has any one of the optical system driving portion that drives the included optical system or the charging portion that charges the electric power causing the included light emission portion to emit light.

In the embodiment mentioned above, the optical system driving portion includes a plurality of driving portions in which the respective driving periods are independently controlled, and the determination portion can select any one of the first determination portion and the second determination portion depending on whether or not the periods driving the driving portions overlap with each other.

In the embodiment mentioned above, in the determination portion, the control portion can select any one of the first determination portion and the second determination portion depending on the charging state of the charging portion.

In the embodiment mentioned above, the accessories include the load portion that is driven by the electric power supplied from the camera, and the load control portion that notifies the camera of the consumption electric energy amount information in the load portion.

In the embodiment mentioned above, in the accessories, the determination threshold value which determines the remaining quantity of the battery supplying the electric power can be changed based on the notified consumption electric energy amount information.

In the embodiment mentioned above, the camera system includes a camera including an attachment and detachment portion where an accessory including a load portion can be attached or detached, a storage portion capable of storing a battery, and a control portion which performs the supply control of the electric power to be output from the battery stored in the storage portion with respect to the accessory mounted on the attachment and detachment portion, and an accessory that is supplied with electric power from the camera, wherein the accessory includes a load portion that is driven by the electric power supplied from the camera, and a load control portion that notifies the camera of the electric power consumption information in the load portion, the control portion in the camera includes a communication portion which communicates with the accessory and acquires the electric power consumption information in the load portion, and a determination portion that determines a remaining quantity of the battery by comparing a value of a power source voltage, which is output from the battery and is detected, with a predetermined determination threshold value, and the determination portion changes the determination threshold value based on the electric power consumption information acquired by the communication portion.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. An electronic equipment comprising:
a main body;
a mounting portion which is provided in the main body and on which an accessory can be mounted;
a battery that is stored in the main body;
a battery voltage detection portion that detects an output voltage of the battery;
an external power source supply portion which supplies the electric power from the battery to the accessory mounted on the mounting portion; and
a control portion which determines a remaining capacity of the battery, on the basis of a threshold value to be set based on an accessory information for the accessory and a detection result of the battery voltage detection portion.

2. The electronic equipment according to claim 1,
wherein the accessory information includes at least one of an identification information of the accessory, a state information of the accessory, and a rated electric power of the accessory.

3. The electronic equipment according to claim 1,
wherein the mounting portion has a structure in which a connection state with the accessory is used in the identification of the accessory.

4. The electronic equipment according to any one of claim 1, further comprising:
a memory portion in which at least one of the identification information of the accessory and the accessory state information, and the rated electric power of the accessory are memorized in association with each other.

5. The electronic equipment according to any one of claim 1, further comprising:
a communication portion that sends the accessory information from the accessory to the control portion.

6. The electronic equipment according to any one of claim 1,
wherein the accessory includes at least one of an optical system driving portion that drives an optical system, a charging portion that charges the electric power causing a light emission portion to emit light, and a GPS signal receiver.

7. The electronic equipment according to any one of claim 1,
wherein the accessory includes an optical system driving portion that drives an optical system,
the optical system driving portion includes a plurality of driving portions that are controlled independently from each other, and
the control portion changes a determination method of the remaining capacity depending on whether or not the driving portion is controlled in an overlapped manner.

8. The electronic equipment according to any one of claim 1,
wherein the accessory includes a charging portion that charges the electric power causing a light emission portion to emit light, and
the control portion changes the determination method of the remaining capacity depending on the charging state of the charging portion.

9. The electronic equipment according to any one of claim 1,
wherein the battery voltage detection portion detects the power source voltage that is repeatedly output from the battery for each predetermined time, and
the control portion determines the remaining capacity of the battery based on an average value of the detection result of the battery voltage detection portion in a predetermined period of time depending on a type or control state of the accessory, or determines the remaining capacity of the battery based on deviation of the detection result of the battery voltage detection portion in a predetermined period of time.

10. The electronic equipment according to any one of claim 1, further comprising:
a display portion that displays the remaining capacity of the battery.

11. The electronic equipment according to claim 10,
wherein the threshold value is a discharge termination voltage determining that the remaining capacity of the battery does not exist, and
the display portion displays the remaining capacity of the battery as a percentage.

12. The electronic equipment according to claim 10,
wherein the display portion displays which stages the remaining capacity of the battery is included on the display portion.

13. The electronic equipment according to claim 1, further comprising:
a voltage stabilization circuit,
wherein the external power source supply portion limits the output voltage of the battery depending on the electric power consumption of the accessory and supplies the accessory with the electric power.

14. The electronic equipment according to claim 13,
wherein the external power source supply portion supplies the accessory with the electric power via the voltage stabilization circuit or without going via the voltage stabilization circuit, depending on the electric power consumption of the accessory.

15. The electronic equipment according to claim 1,
wherein the control portion does not control the accessory when the remaining capacity of the battery based on the output voltage detected by the battery voltage detection portion and the electric power consumption in the accessory is determined to be substantially 0.

16. An electronic equipment comprising:
a main body;
a mounting portion which is provided in the main body and on which an accessory can be mounted;
a battery that is stored in the main body;
a battery voltage detection portion that detects an output voltage of the battery;
an external power source supply portion which supplies the electric power from the battery to the accessory mounted on the mounting portion; and
a control portion which controls the accessory based on an accessory information for the accessory and a detection result of the battery voltage detection portion.

17. The electronic equipment according to claim 16,
wherein the accessory includes a first accessory and a second accessory different from each other, and
the control portion determines the necessity of the electric power consumption limitation in regard to the second accessory upon driving the first accessory based on the accessory information and the detection result of the battery voltage detection portion.

18. The electronic equipment according to claim 17,
wherein the control portion determines the necessity of going via the voltage stabilization circuit in the electric power supply to the accessory, based on the accessory information and the detection result of the battery voltage detection portion.

19. An accessory that is controlled by the electronic equipment according to claim 1, comprising:
a load portion that is driven by the electric power supplied from the electronic equipment, and a load control portion that notifies the electronic equipment of the electric power consumption information in the load portion.

20. The accessory according to claim 19, further comprising:
an optical system driving portion that drives an optical system as the load portion.

21. The accessory according to claim 19, further comprising:
a charging portion that charges the electric power causing a light emission portion to emit light as the load portion.

22. A camera system including the electronic equipment according to claim 1 and/or the accessory according to claim 19.

23. A camera system comprising:
a camera including
an attachment and detachment portion where an accessory including a load portion can be attached or detached,
a storage portion that is capable of storing a battery, and
a control portion which performs the supply control of the electric power to be output from the battery stored in the storage portion with respect to the accessory mounted on the attachment and detachment portion; and
an accessory that is supplied with electric power from the camera,
wherein the accessory includes
a load portion that is driven by the electric power supplied from the camera; and
a load control portion that notifies the camera of the electric power consumption information in the load portion,
the control portion in the camera includes
a communication portion which communicates with the accessory and acquires the electric power consumption information in the load portion; and
a determination portion that determines a remaining quantity of the battery by comparing a value of a power source voltage, which is output from the battery and is detected, with a predetermined determination threshold value, and
the determination portion changes the determination threshold value based on the electric power consumption information acquired by the communication portion.
